(19) United States
(12) Patent Application Publication
(10) Pub. No.: US 2010/0109397 A1
(43) Pub. Date: May 6, 2010

(54) ACTIVE HEAD RESTRAINT FOR A VEHICLE SEAT

(75) Inventors: Steven Bandurksi, Rochester, MI (US); James M. McGowan, Shelby Township, MI (US); Joseph J. Zwolinski, Sterling Heights, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 12/611,202

(22) Filed: Nov. 3, 2009

Related U.S. Application Data
(60) Provisional application No. 61/198,093, filed on Nov. 3, 2008.

(51) Int. Cl. H01R 33/00; B60N 2/427; B60N 2/48

(52) U.S. Cl. 297/216.12; 297/391; 439/34; 439/638

(57) ABSTRACT

An apparatus for providing an electrical connection between a vehicle seat (20) mounted head restraint (14) and an electrical system (50, 52) of the vehicle. The apparatus includes a first electrical connector (702) secured to a support member (40) of the head restraint (14), the first electrical connector (702) being adapted to deliver an electrical signal to a component (640) mounted to the head restraint. A second electrical connector (704) is associated with the electrical system (50, 52) of the vehicle (12). An auto-connect component (710) is connectable to the vehicle seat (20) and is adapted to receive the support member (40) of the head restraint (14) and the first electrical connector (702). The auto-connect component (710) is further adapted to support the second electrical connector (704) and is configured such that the first and second electrical connectors (702, 704) are interconnected automatically upon installing the head restraint (14) on the vehicle seat (20). The auto-connect component (710) is further configured such that the first and second electrical connectors (702, 704) are disconnected automatically upon un-installing the head restraint (14) from the vehicle seat (20).

### RELATED APPLICATIONS

This application claims the benefit of U.S. Provisional Application Ser. No. 61/198,093, filed on Nov. 3, 2008.

### FIELD OF THE INVENTION

The present invention relates to an active head restraint for a vehicle seat. The active head restraint helps protect an occupant of the vehicle.

### BACKGROUND OF THE INVENTION

It is known to provide an apparatus, such as an occupant restraint (e.g., seatbelt), inflatable vehicle occupant protection device (e.g., air bag), impact absorbing structure (e.g., padded or collapsible structures), or a combination thereof, for helping to protect an occupant of a vehicle. One particular apparatus is a head restraint positioned above or at the upper extent of a seat back of a vehicle seat. Head restraints may be adjustable in order to place the head restraint in a desired position relative to differently sized occupants of the vehicle seat. The head restraint may be effective to help protect the occupant of the vehicle seat upon the occurrence of an event for which occupant protection is desired, such as a vehicle impact (e.g., a rear impact). When such an event occurs, the head restraint helps protect the occupant by helping to absorb impacts with the head restraint and by helping to restrict or limit movement of the occupant's head and neck.

### SUMMARY OF THE INVENTION

The present invention relates to An apparatus for providing an electrical connection between a vehicle seat mounted head restraint and an electrical system of the vehicle. The apparatus includes a first electrical connector secured to a support member of the head restraint, the first electrical connector being adapted to deliver an electrical signal to a component mounted to the head restraint. A second electrical connector is associated with the electrical system of the vehicle. An auto-connect component is connectable to the vehicle seat and is adapted to receive the support member of the head restraint and the first electrical connector. The auto-connect component is further adapted to support the second electrical connector and is configured such that the first and second electrical connectors are interconnected automatically upon installing the head restraint on the vehicle seat. The auto-connect component is further configured such that the first and second electrical connectors are disconnected automatically upon un-installing the head restraint from the vehicle seat.

The present invention also relates to an apparatus for providing an electrical connection between a vehicle seat mounted head restraint and an electrical system of the vehicle. The apparatus includes a first electrical connector associated with the head restraint and being for delivering an electrical signal to a component mounted to the head restraint. A second electrical connector is associated with the electrical system of the vehicle. An auto-connect tube is connectable to the vehicle seat. The auto-connect tube comprises a sidewall that helps define an interior chamber of the auto-connect tube. The second electrical connector is disposed in the interior chamber of the auto-connect tube, the auto-connect tube and the second electrical connector are configured such that the second electrical connector is blocked from being removed from the interior chamber and such that the second electrical connector is maintained at a desired orientation in the interior chamber so that the first and second electrical connectors are interconnected automatically when the head restraint is installed on the vehicle seat.

The present invention further relates to an apparatus including a vehicle seat having a seat frame and a head restraint connectable to the vehicle seat. The head restraint includes a support member. An electrical connector assembly for providing an electrical connection with a head restraint mounted component includes a first electrical connector connected to the support member. The first electrical connector is for supplying an electrical signal to the head restraint mounted component. A second electrical connector connected to the vehicle seat is connected to a source of a vehicle electrical signal. An auto-connect tube is secured to the vehicle seat frame and supports the second electrical connector. The auto-connect tube is adapted to receive the support member and to position and support the second electrical connector to automatically interconnect with the first electrical connector when the head restraint is installed on the vehicle seat.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic illustration of a vehicle that includes an apparatus for helping to protect an occupant of a vehicle seat, according to the present invention;

FIG. 2 is a perspective view of a portion of the apparatus, illustrating the apparatus in a non-deployed condition;

FIG. 3 is a perspective view of a portion of the apparatus, illustrating the apparatus in a deployed condition;

FIG. 4 is a sectional view taken generally along line 4-4 in FIG. 2, with certain portions omitted for clarity;

FIG. 5 is a sectional view taken generally along line 5-5 in FIG. 3, with certain portions omitted for clarity;

FIG. 6 is a sectional view taken generally along line 6-6 in FIG. 2, with certain portions omitted for clarity;

FIGS. 7-9 are perspective views of certain portions of the apparatus;

FIG. 10 is a magnified view of a portion of the apparatus of FIG. 6;

FIGS. 11A-11C illustrate portions of the apparatus in different conditions;

FIG. 12 is a perspective view of a portion of the apparatus;

FIGS. 13A-13D illustrate portions of the apparatus in different conditions;

FIGS. 14A-14E illustrate an electrical connector assembly portion of the apparatus;

FIGS. 15A-14D are schematic illustrations depicting the operation of the electrical connector assembly portion of the apparatus; and

FIGS. 16A-16D illustrate an electrical connector assembly according to an alternative embodiment of the invention.

### DESCRIPTION OF THE PREFERRED EMBODIMENTS

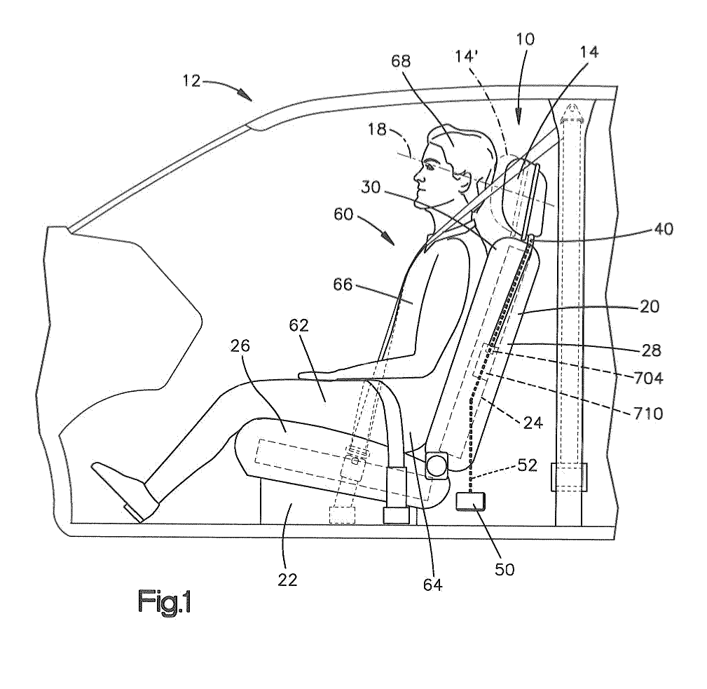

The present invention relates to an apparatus for helping to protect an occupant of a vehicle. More particularly, referring to FIG. 1, the apparatus 10 comprises a vehicle occupant protection device in the form of an active head restraint 14 supported on a seat 20 of a vehicle 12. As shown in FIG. 1, the vehicle seat 20 includes a seat base 22 mounted to the vehicle 12. A seat frame 24 mounted to the seat base 22 supports a seat cushion 26 and a seat back 28. The seat back 28 is adjustable to incline or decline relative to the seat base 22 and cushion 26.

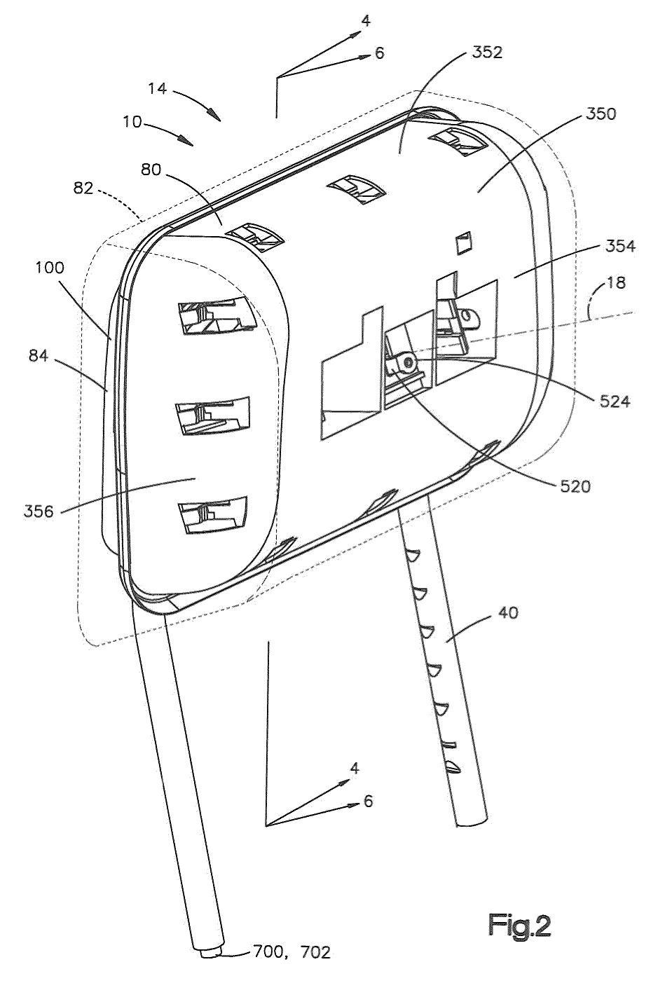

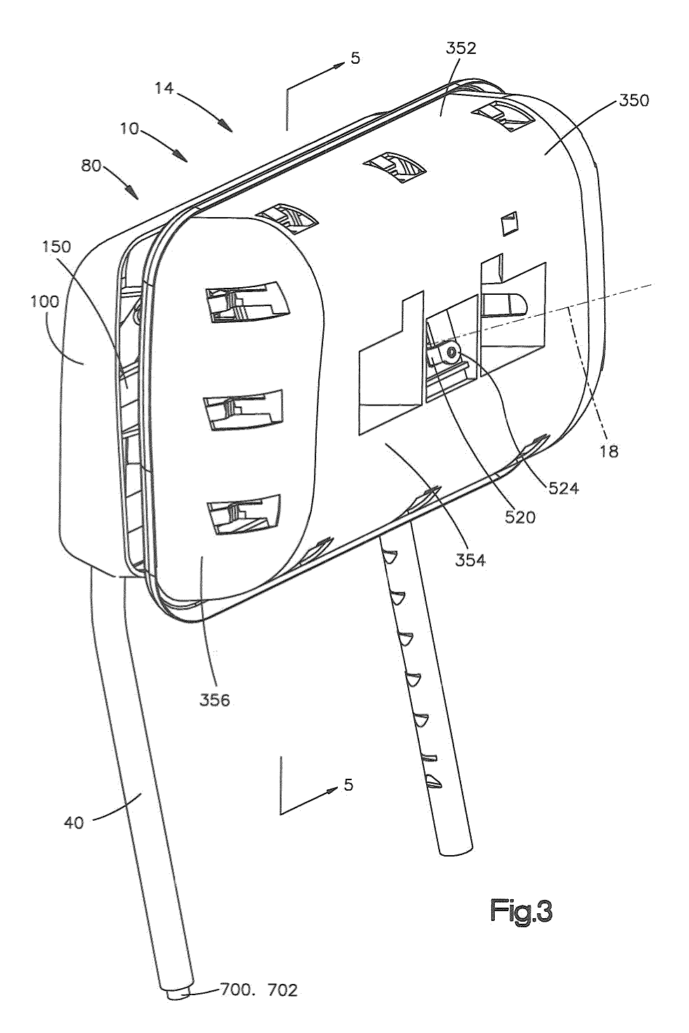

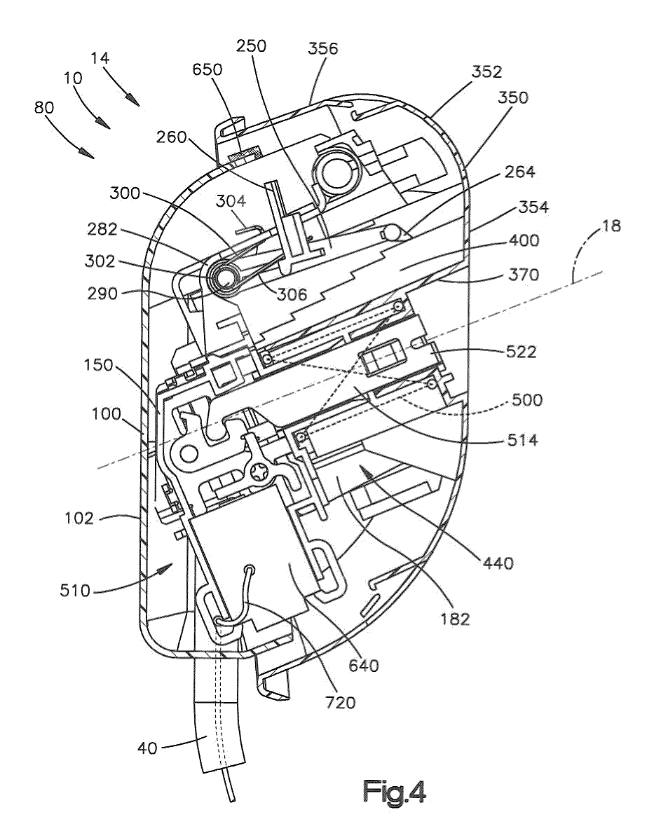

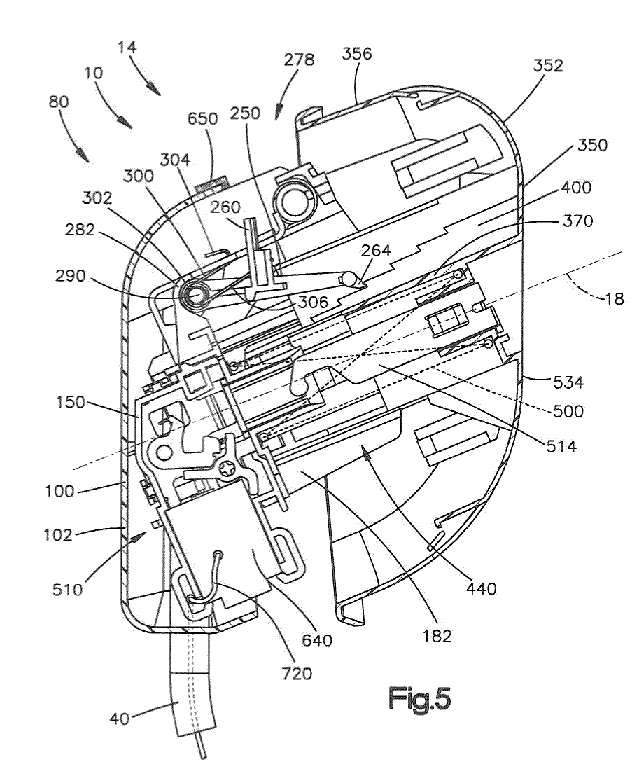

The active head restraint 14 is supported on the seat back 28 via a mount in the form of one or more support rods 40 connected to the seat frame 24. The active head restraint 14 is supported in a position generally adjacent or above an upper end portion 30 of the seat back 28. The active head restraint 14 has a normal, non-deployed condition illustrated generally in solid lines in FIG. 1 (see also FIGS. 2 and 4). The active head restraint 14 is actuatable to a deployed condition illustrated generally in dashed lines at 14′ in FIG. 1 (see also FIGS. 3 and 5).

The apparatus 10 includes a sensor 50, illustrated schematically at in FIG. 1, for sensing an event for which deployment of the active head restraint 14 is desired, such as an impact or collision. In particular, the sensor 50 may be operative to sense a rear impact of the vehicle 12. The sensor 50 may comprise one or more sensing devices (not shown), such as accelerometers, one or more controllers (not shown), or a combination of sensing devices and controllers located local to or remote from the active head restraint 14. The active head restraint 14 is operatively connected to the sensor via lead wires 52.

The sensor may comprise a standalone unit dedicated to sensing only conditions for which deployment of the active head restraint 14 is desired, such as a rear vehicle impact. Alternatively, the sensor 50 may be integrated with a vehicle restraint control module that controls the active head restraint 14 and other vehicle occupant protection devices, such as air bags, seat belts, inflatable curtains, and knee bolsters. In this configuration, the control module of which the sensor 50 forms a portion may actuate the active head restraint 14 or other vehicle occupant protection devices in response to the sensed event. For example, the control module may actuate the active head restraint 14 and other vehicle occupant protection devices in various combinations in response to different sensed conditions, such as a front impact, side impact, rear impact, offset impact, or a vehicle rollover.

The seat 20 may support a vehicle occupant 60. In the embodiment illustrated in FIG. 1, the apparatus 10 is associated with the vehicle seat at a passenger side first row position in the vehicle 12. The apparatus could, however, be associated with a seat in an alternative position (not shown) in the vehicle 12, such as a driver position or a rearward seat position (e.g., 2^{nd} row, 3^{rd} row, etc.).

In the normally seated position illustrated in FIG. 1, the occupant's upper legs 62 and buttocks/pelvis 64 are supported on the seat cushion 26, and the occupant's torso 66 is supported by and rests against the seat back 28. As shown in FIG. 1, in the normally seated position, the occupant's head 68 may be positioned forward of the active head restraint 14.

Referring to FIGS. 2-5, the active head restraint 14 includes a head restraint core 80 upon which a cover 82 (shown in dashed lines in FIG. 2 only) is supported. The cover 82 may have any suitable configuration or construction. For example, the cover 82 may include one or more layers of energy absorbing material, such as foam padding, covered by an outer upholstery layer of material, such a fabric material, a leather material, or a synthetic material. On certain portions of the head restraint core 80, such as a rear portion 84, the cover 82 may have a different construction. For example, the cover 82 may be constructed of a plastic material on the rear portion 84 of the head restraint core 80.

The head restraint core 80 includes a rear cover 100, a base frame 150 that is connected to or otherwise supported on the rear cover, and a cushion carrier 350 supported on the base frame for sliding movement along a deployment axis 18. A drive spring 500 biases the cushion carrier 350 to move relative to the base frame 150 along the deployment axis 18 toward the deployed condition (see 14′ in FIG. 1). As shown in the figures, the deployment axis 18 extends generally diagonally, upward and forward toward the occupant's head 68 as viewed in FIG. 1.

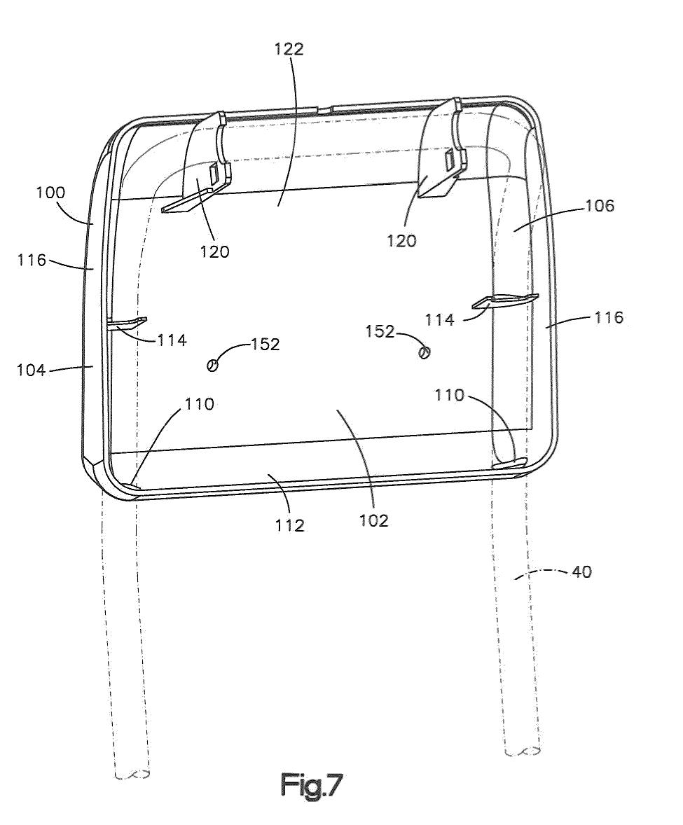

As best shown in FIG. 7, the rear cover 100 is connectable with the support rod 40 to thereby connect the head restraint core 80 to the support rod. The support rod 40 comprises a single elongated piece of a material, such as a metal rod or tube, that is bent or otherwise formed to define an inverted, generally U-shaped portion that engages and is secured to the rear cover 100 and base frame 150 of the head restraint core 80, as described below. Alternative configurations, such as two separate interconnected rods, could also be used to form the support rod 40.

The rear cover 100 illustrated in FIG. 7 is formed as a single piece of material, such as molded plastic. The rear cover 100 includes a generally flat, planar base wall 102 and a peripheral side wall 104 that extends transverse to the base wall along a periphery 106 of the base wall. The rear cover 100 also includes a pair of openings 110 spaced from each other along a lower portion 112 of the side wall 104. The rear cover 100 also includes a pair of first support portions 114 that are positioned spaced from each other adjacent opposite lateral portions 116 of the side wall 104. Each of the first support portions 114 is aligned with a respective one of the openings 110 in the lower portion 112 of the side wall 104. The rear cover 100 further includes a pair of second support portions 120 that are positioned spaced from each other along an upper portion 122 of the side wall 104.

In the illustrated embodiment, the rear cover 100 and base frame 150 are separate pieces connectable with each other via means (not shown) such as interlocking (e.g., snap-fit) portions, fasteners, or a combination of interlocking portions and fasteners. Alternatively, the rear cover 100 and base frame 150 could be formed as a single integrated component, e.g., via molding.

In the illustrated embodiment, the base frame 150 is connected to the rear cover 100 by known means (not shown), such as fasteners installed through respective fastener openings 152 in the base frame 150 and rear cover 100. The support rod 40 extends through the openings in the rear cover 100 and is positioned against the first and second support portions 114 and 120 of the rear cover. With the support rod 40 in the position shown in FIG. 7, the base frame 150 is connected to the rear cover 100. When the base frame 150 is connected to the rear cover 100, the support rod 40 becomes clamped between a support rod receiving portion 154 of the base frame 150 and the second support portions 120 of the rear cover 100. This connection is effective to secure the support rod 40 and form an assemblage of the support rod, rear cover 100, and base frame 150.

The base frame 150 includes a base portion 160 and a track portion 180. The base portion 160 abuts the rear cover 100 and is secured to the rear cover. The track portion 180 extends from the base portion 160 away from the rear cover 100. The track portion 180 supports the cushion carrier 350 for sliding movement along the deployment axis 18.

The base portion 160 of the base frame 150 includes a central portion 162 and flange portions 164 that extend laterally from opposite sides of the central portion. The flange portions 164 include base portions 166 that abut the rear cover 100 and through which fastener openings 152 extend. The fastener openings 152 are configured to receive fasteners (not shown) for securing the base frame 150 to the rear cover 100. Reinforcing portions 170 extend between the base portions 166 and the track portion 180 and help improve the strength and structural integrity of the base frame 150.

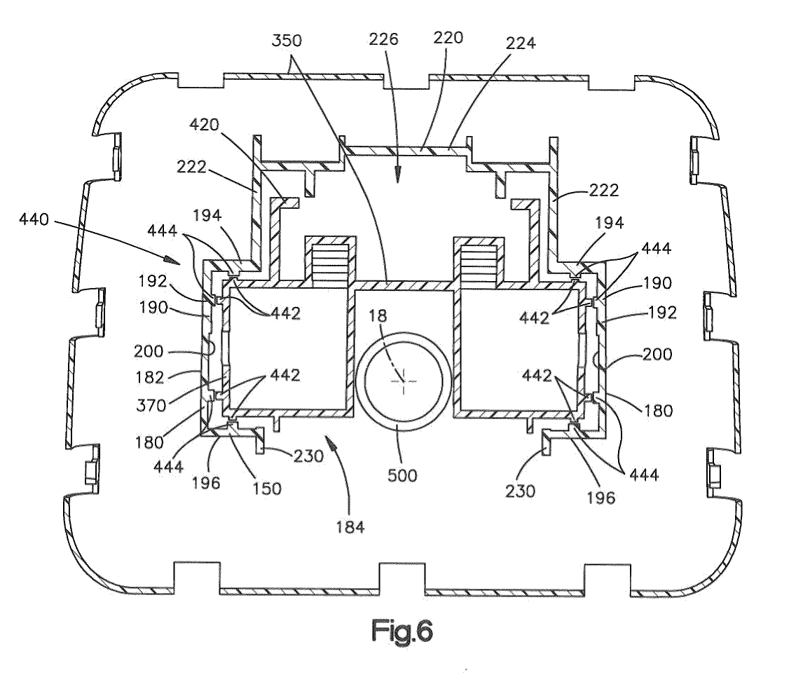

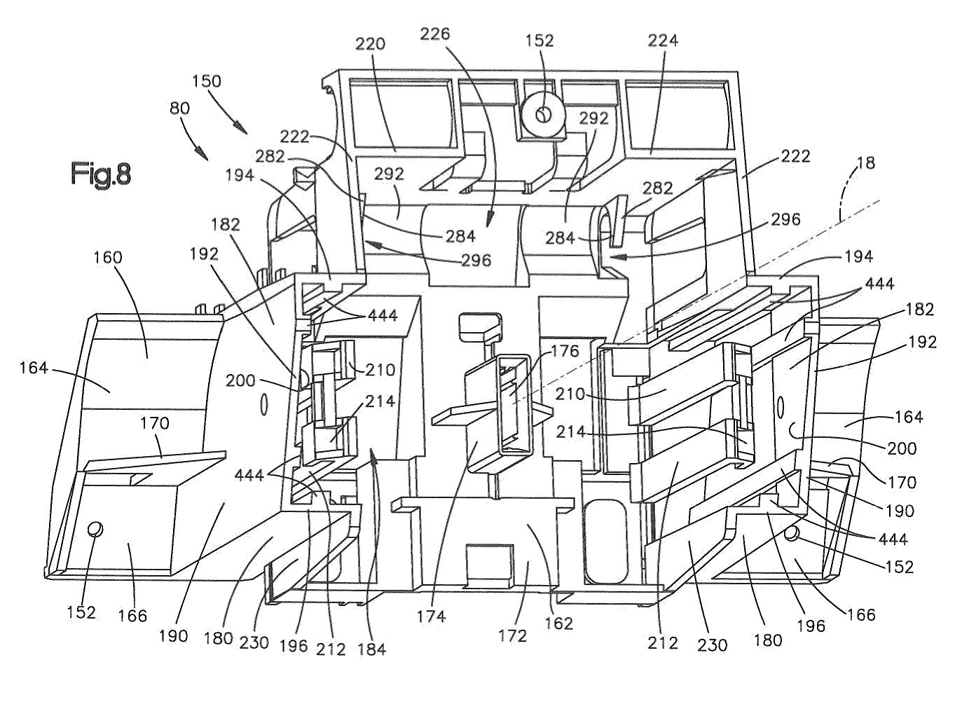

The central portion 162 of the base frame 150 includes an actuator support portion 172 positioned at a lower extent of the central portion, as viewed in FIGS. 6 and 8. The actuator support portion 172 is configured to receive and mate with an actuator associated with a release mechanism (not shown in FIGS. 6 and 8) that is discussed below in greater detail. The shape and form of the actuator support portion 172 may correspond to the shape and form of the actuator.

The central portion 162 of the base frame 150 also includes a spring support portion 174 for receiving an end portion of the drive spring 500 of the head restraint core 80. The spring support portion 174 is generally elongated and rectangular in shape and is centered generally on the deployment axis 18. The spring support portion 174 projects from the central portion 162 along the deployment axis 18. The spring support portion includes a slot 166 for receiving a tongue portion of a release latch mechanism (not shown in FIGS. 6 and 8) of the head restraint core 80.

The track portion 180 of the base frame 150 includes a portion that defines a fixed track member 182 of the head restraint core 80. The fixed track member 182 extends away from the base wall 102 of the rear cover 100 in a direction generally parallel to the deployment axis 18 of the head restraint core 80. The fixed track member 182 defines a generally rectangular or rectilinear channel 184. The fixed track member 182 includes spaced beam portions 190 that extend generally parallel to the deployment axis 18. The beam portions 190 have generally squared C-shaped configurations, each including a vertical member 192, an upper cross-member 194, and a lower cross-member 196. The beam portions 190 thus serve in the manner of a C-shaped beam to help improve the strength and rigidity of the fixed track member 182.

The beam portions 190 are spaced laterally from each other and oriented such that opposing surfaces 200 of the beams, defined by respective surfaces of the vertical members 192 and the cross-members 194 and 196, help define opposite lateral extents of the channel 184. The opposing surfaces 200 have a squared C-shaped configuration, thus giving the channel 184 its generally rectangular or rectilinear configuration. Latch members 210 positioned in the channel 184 adjacent each beam portion 190 have leg portions 212 that extend away from the central portion 162 of the base frame 150 in a direction generally parallel to the deployment axis 18. Each latch member 210 has a terminal latch hook portion 214 that projects laterally from the leg portion 212 toward the vertical member 192 of the adjacent beam portion 190. The latch members 210 have generally resilient configurations and can be deflected toward or away from the deployment axis 18.

The beam portions 190 are interconnected with each other via an upper transverse portion 220 of the fixed track member 182. The upper transverse portion 220 includes respective vertical members 222 that extend vertically upward, as viewed in FIGS. 6 and 8, from the upper cross-members 194 of the beam portions 190. The upper transverse portion 220 also includes a cross member 224 that extends between and interconnects the vertical members 222. The upper transverse portion 220 helps define a lock channel 226. The fixed track member 182 may also include lower reinforcing members 230 that extend vertically downward, as viewed in FIGS. 6 and 8, from the lower cross-members 196 of the beam portions 190.

The beam portions 190, upper transverse portion 220, the lower reinforcing members 230, or any combination of these elements, may be connected to and extend from the base wall 102 of the rear cover 100 (see, e.g., FIG. 7). This may be achieved, for example, by molding the beam portions 190, the upper transverse portion 220, the lower reinforcing members 230, or any combination of these elements with the base wall 102 as a single piece of molded plastic material.

The lock channel 226 is configured to receive and support a non-return pawl 250. Referring to FIGS. 4, 5, 8, and 12, the non-return pawl 250 includes spaced elongated pawl arm portions 252 interconnected by a central cross member 254 and a front cross member 256. A reset lever 260 extends perpendicularly from the central cross member 254 in a direction generally upward as viewed in FIGS. 4, 5, and 12.

Each pawl arm portion 252 includes a terminal end portion 262 that defines a rack engaging portion 264 of the non-return pawl 250. The rack engaging portions 264 extend angularly from the pawl arm portions 252 in directions generally downward and forward as viewed in FIGS. 4, 5, and 12.

The rack engaging portions 264 include a generally planar, downwardly facing lower rack engaging surface 270 and a generally planar, forward facing stop surface 272 that intersects the rack engaging surface at an acute angle. As best shown in FIGS. 4 and 5, the rack engaging portions 264 project generally downward from the pawl arm portions 252 such that the rack engaging portions are positioned offset from and vertically below a lower surface 274 of the pawl arm portions.

Each pawl arm portion 252 also includes a terminal end portion opposite the rack engaging portions that defines a pivot portion 276 of the non-return pawl 250. Each pivot portion 276 includes generally rounded pivot surfaces 280 that are received in and engage corresponding non-return latch receiving portions 282 of the base frame 150 (see FIG. 8). The pivot surfaces 280 are centered on a pivot axis 284 of the non-return pawl 250. Each pivot portion 276 also includes a retention member 286 that projects laterally outward from an outer surface 288 of the pivot portion. The retention portions 286 have a generally elongated tapered configuration and extend generally parallel to the length of the pawl arms 252.

The non-return pawl 250 also includes a spring receiving portion 290 that projects inward from one of the pivot portions toward the other of the pivot portions 280. The spring receiving portion 290 has a generally cylindrical configuration and is centered along with the pivot portions 280 on the pivot axis 284 of the non-return pawl 250. The non-return pawl 250 further includes a reset pin 292 that projects laterally from an outer surface of one of the pawl arm portions 252 adjacent or near the rack engaging portion 264. The reset pin 292 has a generally cylindrical configuration and is aligned with the front cross member 256.

To assemble the non-return pawl 250 with the base frame 150, the pivot portions 280 are installed in the corresponding non-return latch receiving portions 282 of the base frame 150 (see FIG. 8). As shown in FIG. 8, the non-return latch receiving portions 282 include a cylindrical pawl receiving surface 292 upon which the pivot surfaces 280 of the pawl arm portions 252 are held and supported for pivoting movement about the pivot axis 284. As the non-return pawl 250 pivots about the pivot axis 284, the pivot portions 280 slide on the pawl receiving surface 292.

The non-return pawl receiving portions 282 also include lateral retention walls 294 that maintain the lateral position of the non-return pawl 250. The retention walls 294 leave a gap or opening 296 through which the retention portions 286 of the pawl arm portions 252 extend when the non-return pawl 250 is installed. To do this, the non-return pawl 250 is installed at an angle relative to the base frame 150 that falls within a predetermined range so that the elongated retention portions pass through the openings 296. Once installed, the non-return pawl 250 is pivoted upward to a position such that the retention portions 286 are blocked from removal by the retention walls 294, thus locking the non-return pawl 250 in the non-return pawl receiving portion 282 of the base frame 150. Thereafter, when a sliding track member 370 of the cushion carrier 350 is installed in the fixed track member 182 of the base frame 150, the non-return pawl 250 is prevented from pivoting to a position where it can be removed from the non-return pawl receiving portion 282.

In the installed condition (see FIGS. 4 and 5), a non-return pawl biasing coil spring 300 is installed. A central coil portion 302 of the coil spring 300 is installed on the spring receiving portion 290. A first end portion 304 of the coil spring 300 is secured or placed in engagement with the base frame 150 and a second end portion 306 is secured or placed in engagement with the non-return pawl 250. The coil spring 300 biases the non-return pawl 250 such that rack engaging portions 264 are urged into engagement with rack latch portions 402 on the cushion carrier 350.

Referring to FIGS. 2-5 and 9, the cushion carrier 350 includes a cushion support portion 352 with a front wall 354 and a side wall 356 that projects from the front wall about a periphery of the front wall. The side wall 356 includes a series of connecting portions 360 spaced about the periphery of the cushion carrier 350 for securing the cover 82 (see FIGS. 2 and 3) to the cushion carrier 350.

The cushion carrier 350 includes a portion that defines a sliding track member 370 of the head restraint core 80. For example, the sliding track member 370 may be formed integrally with the cushion carrier 350, e.g., via molding. Alternatively, the sliding track member 370 could be formed as a piece separate from and connectable with the cushion carrier 350, e.g., via fasteners or a snap-fit that connects the sliding track member to the front wall 354 of the cushion carrier.

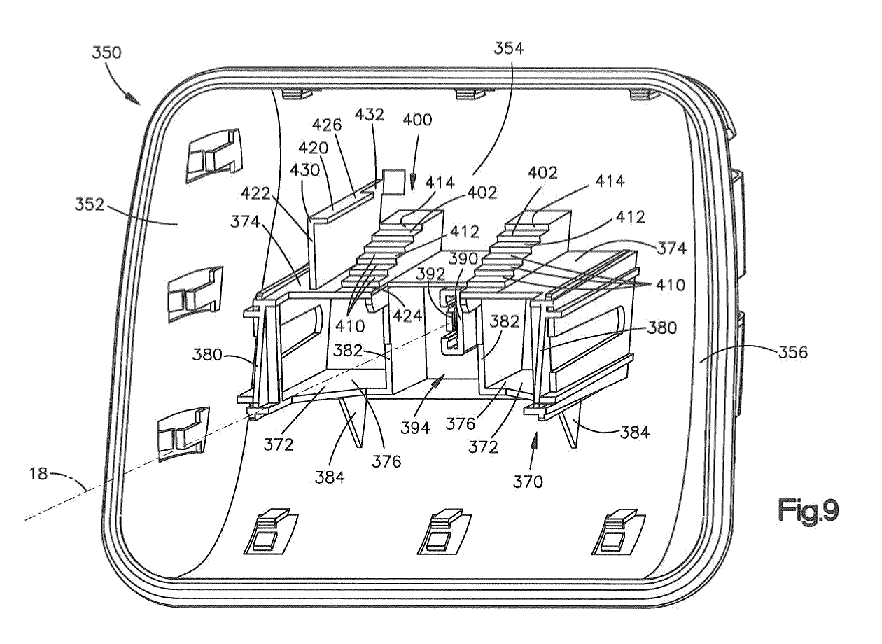

The sliding track member 370 extends away from the front wall 354 of the cushion carrier 350 along the deployment axis 18 of the head restraint core 80. As best shown in FIGS. 6 and 9, the sliding track member 370 has a generally rectangular configuration and includes two generally rectangular box-shaped sliding frames 372 (FIG. 9) spaced laterally from each other. The sliding frames 372 extend generally parallel to the deployment axis 18. Each sliding frame 372 includes upper and lower walls 374 and 376, respectively, that extend generally horizontally (as viewed in FIG. 6) and lateral end walls 380 and 382, respectively, that extend generally vertically (as viewed in FIG. 6). The end walls 380 and 382 extend between and interconnect the upper and lower walls 374 and 376. The sliding frames 372 thus have a generally closed configuration, which helps improve the strength and rigidity of the sliding track member 370.

The sliding track member 370 may also include lower reinforcing members 384 that extend vertically downward from each lower wall 376 of the sliding frame 372. The reinforcing members 384 provide a corner brace between the lower walls 376 and the front wall 354 of the cushion carrier 350. The upper walls 374, lower walls 376, end walls 380 and 382, and reinforcing portions 384, or any combination of these elements, may be connected to and extend from the front wall 354 of the cushion carrier 350. This may be achieved, for example, by forming the upper wall 374, lower wall 376, end walls 380 and 382, reinforcing portions 384, or any combination of these elements with the front wall 354 as a single piece of molded plastic material.

The cushion carrier 350 also includes a spring support portion 390 for receiving an end portion of the drive spring 500 opposite the end portion received by the spring support portion 174 of the base frame 150. The spring support portion 390 is positioned in a space 394 defined between the sliding frames 372. The spring support portion 390 is centered generally on the deployment axis 18 and projects from the front wall 354 in a direction generally parallel to the deployment axis. The spring support portion 390 has a generally elongated rectangular configuration and includes a slot 392 for receiving the tongue portion of the release latch (not shown in FIGS. 6 and 9).

The cushion carrier 350 further includes a non-return latch portion 400 positioned above the upper walls 374 of the sliding frames 372. The non-return latch portion 400 includes two latch rack portions 402 that are spaced apart from each other, one positioned on the upper wall 374 of one sliding frame 372 and one positioned on the upper wall of the other sliding frame. The latch rack portions 402 have stepped configurations and include a plurality of steps 410 that step upward toward the front wall 354 of the cushion carrier 350. Each step 410 includes a sliding surface 412 and a latching surface 414 that extends transverse to the sliding surface, generally vertically as viewed in FIG. 9.

The non-return latch portion 400 also includes a latch reset guide 420 that projects vertically from the upper wall 374 of the leftmost sliding frame 372 as viewed in FIG. 9. The latch reset guide 420 is positioned just to the left of the leftmost latch rack 402 portion as viewed in FIG. 9. The latch reset guide 420 includes a vertical support wall 422 that intersects and extends from the front wall 354 of the cushion carrier 350 to adjacent or near a terminal latch surface 424 of the adjacent latch rack portion 402. The latch reset guide 420 also includes an overhang portion 426 that extends along a portion of an upper edge portion 430 of the support wall 422 and projects toward the adjacent latch rack portion 402. The overhang portion 426 terminates short of the front wall 354 of the cushion carrier 350, forming a reset gap 432 between the terminal end of the overhang portion and the front wall.

The base frame 150 supports the cushion carrier 350 for movement along the deployment axis 18 in generally fore and aft directions in the vehicle 12 between the non-deployed condition (FIGS. 2 and 4) and the deployed condition (FIGS. 3 and 5). The fixed track member 182 of the base frame 150 and the sliding track member 370 of the cushion carrier 350, in combination, help form a track assembly 440 (FIGS. 2-5) for facilitating movement of the cushion carrier 350 relative to the base frame 150 along the deployment axis 18.

As best shown in FIGS. 6 and 8-10, the sliding track member 370 includes first interface portions 442 that engage second interface 444 portions on the fixed track member 182 and support the sliding track member 370 for sliding movement relative to the fixed track member. A pair of first interface portions 442 are located at each of four corner locations of the sliding frame 372, i.e., at the two intersections between the upper walls 374 and the end walls 380 and 382, and at the two intersections between the lower walls 376 and the end walls 380 and 382.

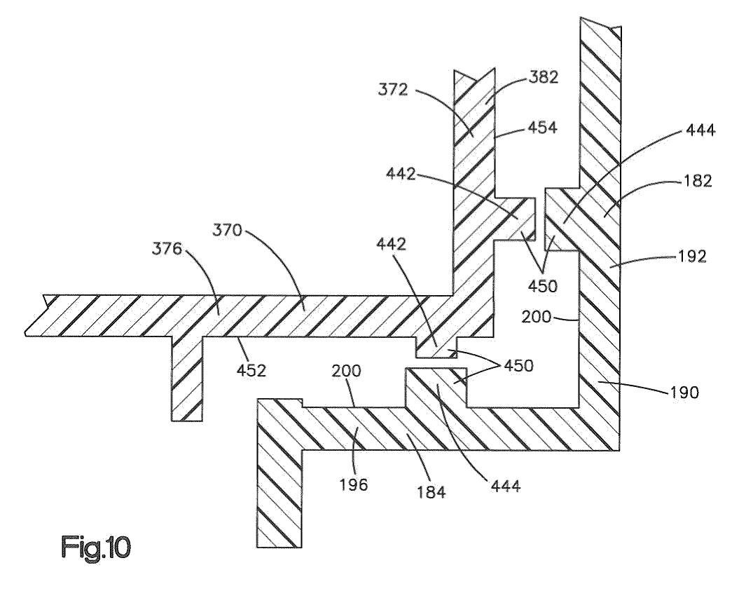

A complementary pair of second interface portions 444 are located at each of the four corner locations of the rectangular channel 184 of the fixed track member 182, i.e., at the two intersections between the upper cross-members 194 and the vertical members 192, and at the two intersections between the lower cross-members 196 and the vertical members 192. To illustrate the configuration of the interface portions 442 and 444 in detail, a magnified view of one of the corners of a sliding frame 372 and corresponding rectangular channel 184, particularly the lower right corner as viewed in FIG. 6, is illustrated in FIG. 10.

The first interface portions 442 comprise axially extending beads 450 that extend along the length of the sliding frame 372 and have generally rectangular cross-sections. Alternatively, the beads 450 may have rounded cross-sections, rectangular cross-sections with rounded corners, or rectangular cross-sections with chamfered corners. The direction in which the first interface portions 442 extend is generally parallel to the deployment axis 18. One of the first interface portions 442 projects from a lower surface 452 of the lower wall 376 of the sliding frame 372. Another of the first interface portions 442 projects from an outer surface 454 of the lateral end wall 382 of the sliding frame 372. Those skilled in the art will appreciate that the interface portions associated with intersections at the other corner locations of the sliding frame not shown in FIG. 10 (see FIGS. 6 and 9) project similarly from the lower surface of the lower wall 376, an upper surface of the upper wall 374, and the outer surface of the lateral end walls 380 and 382 at those respective corner locations.

One of the second interface portions 444 projects from the opposing surface 200 of the lower cross-member 196 of the beam portion 190 of the fixed track member 182. Another of the second interface portions 444 projects from the opposing surface 200 of the vertical member 192 of the beam portion 190 of the fixed track member 182. Those skilled in the art will appreciate that the second interface portions 444 associated with intersections at the other corner locations of the fixed track member 182 not shown in FIG. 10 (see FIGS. 6 and 8) project similarly from the opposing surfaces 200 of the lower cross-member 196, the upper cross-member 194, and the vertical member 192, respectively, at those respective corner locations.

As best shown in FIG. 6, the sliding track member 370 is supported for sliding movement within the channel 184 of the fixed track member 182. More particularly, the sliding track member 370 is supported for sliding movement on the fixed track member 182 by the first and second interface portions 442 and 444. The first interface portions 442 on the sliding frame 372 of the sliding track member 370 engage and slide along the corresponding second interface portions 444 of the opposing surfaces 200 of the beam portions 190 of the fixed track member 182. The first and second interface portions 442 and 444 provide engagement between the fixed track member 182 and sliding frame 370 that has a relatively small surface area, which facilitates sliding movement through reduced friction.

In FIG. 10, the interface portion 442 on the lower surface 452 of the sliding frame 370 engages the interface portion 444 on the adjacent surface of the lower cross-member 196. The interface portion 442 on the outer surface 454 of the lateral end wall 382 of the sliding frame 372 likewise engages the interface portion 444 on the adjacent surface of the vertical member 192 of the beam portion 190 of the fixed track member 182. Those skilled in the art will appreciate that the interface portions 444 associated with intersections at the other corner locations of the sliding frame 372 not shown in FIG. 10 (see FIGS. 6, 8, and 9) engage respective interface portions of the fixed track member 182.

Referring to FIG. 4, in the non-deployed condition of the head restraint core 80, the drive spring 500 is arranged in compression within the space 394 defined between the sliding frames 372 and is supported at opposite ends by the respective spring support portions 174 and 390 of the base frame 150 and the cushion carrier 350. The coil of the drive spring 500 has an inside diameter that fits over the spring support portions 174 and 390 with a close fit. The drive spring 500 is configured and arranged in compression to provide a driving or actuating force to move the head restraint core 80 from the non-deployed condition of FIGS. 2 and 4 to the deployed condition of FIGS. 3 and 5.

The drive spring 500 may have various alternative configurations. For example, in one embodiment, the drive spring 500 may comprise a single spring that applies the driving force for actuating the head restraint core 80. As an alternative, the drive spring 500 may comprise two or more springs for applying a driving force that varies during deployment. For instance, the drive spring may comprise two springs, one having a length that is shorter than the other and having a diameter smaller than the other. The shorter, smaller diameter spring could be positioned concentrically with the larger spring within the inside diameter of the larger spring. In this instance, both springs would initially apply the driving force to the cushion carrier 350, with the shorter spring becoming fully extended and ceasing to apply driving force at a predetermined point, thus allowing the longer spring to continue driving the cushion carrier to the fully extended condition. Thus, in this configuration, the cushion carrier 350 may be deployed initially with a first driving force by both springs followed by a second, comparatively lesser or weaker driving force by a single spring.

In another example configuration, the drive spring 500 may not exert the driving force over the full distance of travel of the cushion carrier 350. The drive spring 500 may, for instance, be unconnected to the head restraint core 80 at one end and have a length selected such that the spring becomes fully extended prior to the cushion carrier 350 reaching the fully deployed condition. In this instance, the drive spring 500, when fully extended, would release or “launch” the cushion carrier 350 to travel to the fully deployed condition under its own momentum.

In yet another configuration, the drive spring 500 may comprise a variable rate spring that has a variable force versus displacement characteristics that are selected to achieve the desired deployment characteristics of the head restraint core 80. For example, the drive spring 500 may be selected to have a stiffness that increases proportionally with the degree to which the drive spring is compressed. Thus, in this example, the drive spring 500 would exert greater degree of force initially, and thereafter exert a lesser degree of force as the spring deploys or decompresses.

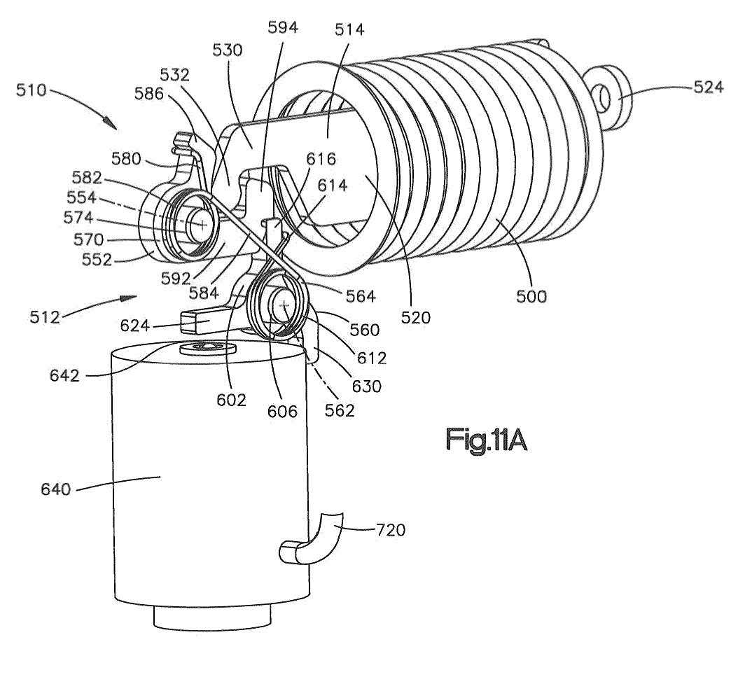

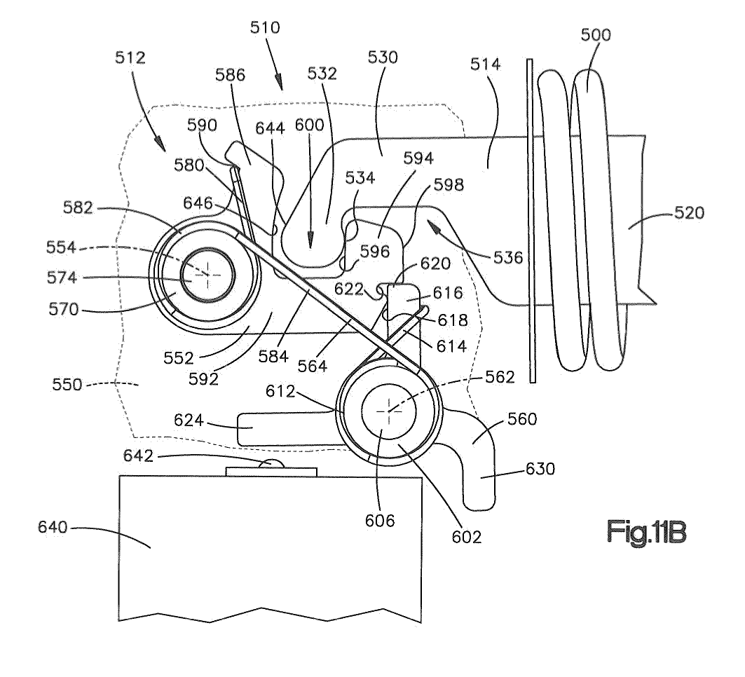

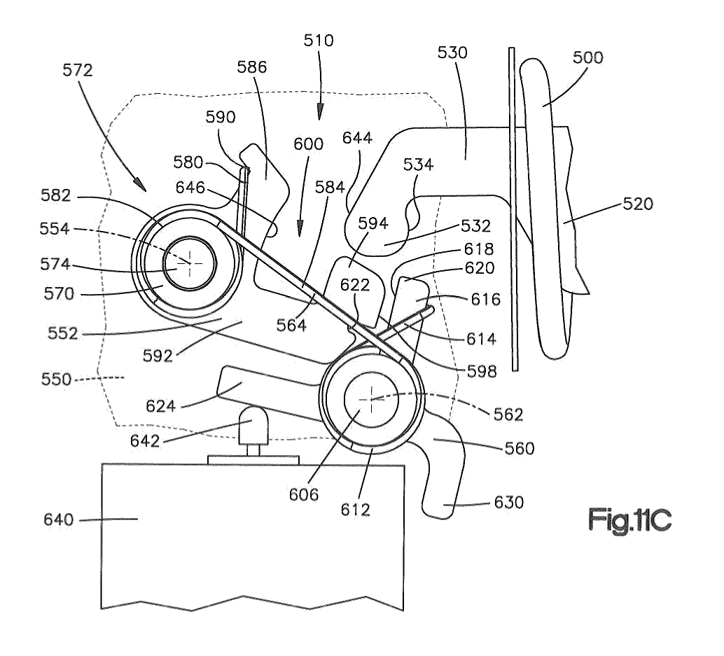

The head restraint core 80 of the active head restraint 14 also includes a release mechanism 510. The release mechanism 510 functions to maintain the head restraint core 80 in the non-deployed condition and is actuatable to release the head restraint core to move to the deployed condition under the driving force of the drive spring. The release mechanism 510 may comprise any suitable structure capable of releasably locking the active head restraint 14 in the non-deployed condition. One particular embodiment of the release mechanism 510 is shown in FIGS. 4 and 5 and is illustrated in greater detail in FIGS. 11A-11C.

The release mechanism 510 includes a latch mechanism 512 secured to the base frame 150 and a tongue 514 that is secured to the cushion carrier 350 and moves with the cushion carrier 350 relative to the base frame 150. The tongue 514 is a generally elongated member constructed of a metal plate material or other suitably strong and durable material. The tongue 514 has a main body portion 520 that extends through the slot 392 in the spring support portion 390 of the cushion carrier 350 and through the central space 502 of the drive spring 500.

The tongue 514 has a mounting portion 522 for securing the tongue to the cushion carrier 250. The mounting portion 522 may have any configuration suited to connect the tongue 514 to the cushion carrier 350. For example, as shown in the illustrated embodiment, the metal plate from which the tongue 514 is formed is cut and bent to form mounting flanges 524 that extend perpendicularly from the main body portion 520. In this example configuration, openings 526 in the mounting flanges 524 receive fasteners (not shown) that pass through the openings and connect the mounting portion 522 to the cushion carrier 350.

Opposite the mounting portion 522, the tongue 514 includes a hook portion 530 that engages the latching mechanism 512. The hook portion 530 has a generally rounded terminal end portion 532 that helps define a latch engaging surface 534 of the tongue 514. The latch engaging surface 530 of the end portion 532 defines a recess 536 into which a portion of the latch mechanism 512 enters and engages the latch engaging surface 530.

The latching mechanism 512 includes a latch frame 550 that is secured to the base frame 150. The latch frame 550 supports a latch member 552 for pivotal movement about a first axis 554 and a blocking member 560 supported for pivotal movement about a second axis 562. A double coil spring 564 biases the latch member 552 to pivot about the first axis 554 in a clockwise direction as viewed in FIGS. 11A-11C. The double coil spring 564 also biases the blocking member 560 to pivot about the second axis 562 in a counterclockwise direction as viewed in FIGS. 11A-11C.

The latch member 552 includes a hub portion 570 with a central opening for receiving a first pin 574 supported by the latch frame 550 to thereby connect the latch member to the latch frame. The double coil spring 564 has a first coiled portion 582 that is fit onto the first pin 574. The latch member 552 includes a spring engaging portion 586 that extends or projects from the hub portion 570 in a direction generally vertically as viewed in FIGS. 11A-11C. The spring engaging portion 586 includes surfaces that meet each other at an angle to form a notch 590 that receives a first end portion 580 of the double coil spring 564.

The latch member 552 also includes a tongue engaging portion 592 that receives the hook portion 530 of the tongue 514. The tongue engaging portion 592 extends or projects from the hub portion 570 in a direction generally horizontally to the right as viewed in FIGS. 11A-11C. The tongue engaging portion 592 includes an upwardly extending terminal end portion 594 that defines a tongue engaging surface 596 of the latch member 552. The tongue engaging portion 596 and the spring engaging portion 586 together help define a recess 600 that receives the hook portion 530 of the tongue 514.

The blocking member 560 includes a hub portion 602 with a central opening for receiving a second pin 606 supported by the latch frame 550 to thereby connect the blocking member to the latch frame. The double coil spring 564 includes a second coiled portion 612 that is fit onto the second pin 606. The blocking member 560 includes a spring engaging portion 616 in the form of a generally straight arm that extends or projects from the hub portion 602 in a direction generally vertically as viewed in FIGS. 11A-11C. The double coil spring 564 includes a second end portion 614 that engages the spring engaging portion 616 of the blocking member 560. As shown in FIG. 11B, a corner portion 620 of a terminal end of the spring engaging portion 616 is received in and engages a notch 622 formed in the tongue engaging portion 592 of the latch member 552.

The double coil spring 564 has a central connector portion 584 that extends between and connects the first and second coil portions 582 and 612. The central connector portion 584 allows the second pin 606 to serve as a reaction member for the bias of the first coiled portion 582. Conversely, the central connector portion 584 allows the first pin 574 to serve as a reaction member for the bias of the second coiled portion 612.

The blocking member 560 also includes an actuator arm 624 that extends or projects from the hub portion 602 in a direction generally horizontally to the left as viewed in FIGS. 11A-11C. The actuator arm 624 has a generally elongated, straight and rectangular configuration. The blocking member 560 also includes a counterbalance arm 630 that extends or projects from the hub portion 602 in a direction generally to the right as viewed in FIGS. 11A-11C and includes a generally downturned end portion. The counterbalance arm 630 serves to make the blocking member 560 inertially neutral about the axis 562. This helps prevent movement of the vehicle 12, such as those experienced during normal or routine driving conditions, from imparting rotation of the blocking member 560.

The release mechanism 510 further includes an actuator 640 for actuating the latching mechanism 512. The actuator 640 may comprise any actuatable device suited to provide repeatable and reliable actuation of the latching mechanism 512. For example, in the illustrated embodiment, the actuator 640 comprises a solenoid. The solenoid is energizeable to move an actuator pin 642 into engagement with the actuator arm 624 of the blocking member 560. Alternatively, the actuator 640 may comprise a pyrotechnic device (not shown), such as a squib or initiator, arranged in a cylinder to drive a piston that moves a similar actuator pin. As a further alternative, the actuator 640 may comprise an actuatable fastener (not shown), such as a separation bolt, arranged to move or release the blocking member 560. Such an actuatable fastener may, for example, have a configuration similar or identical to any of those shown in U.S. Pat. No. 7,240,917 B2 and U.S. Pat. No. 6,746,044 B2, which are hereby incorporated by reference in their entirety.

The release mechanism 510 is movable between a locking condition (FIGS. 11A and 11B) in which the head restraint core 80 is maintained in the non-deployed condition and a non-locking condition (FIG. 11C) in which the head restraint core is actuated to the deployed condition. In the locking condition, the blocking member 560 maintains the position of the latch member 552 to that illustrated in FIGS. 11A and 11B against the bias of the double coil spring 564. The double coil spring 564 biases the blocking member 560 toward the position illustrated in FIGS. 11A and 11B. In this condition, the corner portion 620 of the spring engaging portion 616 is received in and engages the notch 622 formed in the tongue engaging portion 592 of the latch member 552 and thereby helps maintain the latching mechanism 512 in the locking condition and the head restraint core 80 in the non-deployed condition. In this condition, the tongue engaging portion 592 of the latch member 552 receives the hook portion 530 of the tongue 514 such that the latch engaging surface 534 of the hook portion engages the tongue engaging surface 596 of the latch member 552.

Upon sensing the occurrence of an event for which deployment of the active head restraint 14 is desired, such as a rear impact to the vehicle having a magnitude that meets or exceeds a predetermined threshold, the sensor 50 provides a signal to the actuator 640 of the release mechanism 510 via the lead wires 52. Upon receiving the signal from the sensor 50, the actuator 640 is actuated to actuate the release mechanism 510 to thereby release the cushion carrier 350 to move toward the deployed condition. The active head restraint 14, when in the deployed condition, helps protect the vehicle occupant 60 helping to cushion, restrain, or otherwise prevent certain movements of the occupant's head and neck.

Referring to FIG. 11C, when the actuator 640 is actuated, i.e., energized, the actuator pin 642 is thrust axially into engagement with the actuator arm 624 of the blocking member 560. To help ensure that the actuator 640 actuates the release mechanism 510, the controller 50 may be configured to energize the actuator more than once in rapid succession. As a result, the blocking member 560 pivots clockwise as viewed in FIG. 11C against the bias of the double coil spring 564. When this occurs, the corner portion 620 of the spring engaging portion 616 moves out of the notch 622 in the tongue engaging portion 592 of the latch member 552. This allows the latch member 550 to pivot clockwise as viewed in FIG. 11C under the bias of the double coil spring 564. When this occurs, the tongue engaging portion 592 of the latch member 552 moves out of engagement with the hook portion 530 of the tongue 514, thus releasing the tongue 514 and thus the cushion carrier 350 to move along the deployment axis 18 toward the deployed condition.

When the cushion carrier 350 reaches the end of travel, the cushion carrier engages the latch hook portions 214 of the latch members 210. This prevents the cushion carrier 350 from moving further along the deployment axis 18. Advantageously, the end-of-travel stopping functionality of the head restraint core 80 is configured integrally with the base frame 150, thus eliminating the need for additional parts to provide this function.

Advantageously, the latch engaging surface 534 of the hook portion 530 has a rounded configuration so that the hook portion engages the tongue engaging portion 592 at a point along the latch engaging surface of the hook portion. This helps minimize the contact area between the hook portion 530 and the latch member 552, which helps reduce friction and therefore the resistance to movement of the latch member in releasing the tongue 514. This helps improve, i.e., reduce the delay between actuation of the release mechanism 510 and deployment of the cushion carrier 350.

As the cushion carrier 350 moves toward the deployed condition, the sliding track member 370 slides within the channel 184 along the fixed track member 182, riding on and supported by the second interface portions 444. The first interface portions 442 on the sliding track member 370 engage and slide along the corresponding first interface portions 442 on the beam portions 190. This provides reduced frictional resistance to deployment due to the small surface area over which the interface portions 442 and 444 engage each another.

Also, as shown in FIG. 6, the interface portions 442 and 444 are fit within the channel 184 with a relatively close tolerance, thus helping to prevent the parts from moving relative to each other and rattling during vehicle operation. Those skilled in the art will thus appreciate that this design is advantageous in that it helps prevent such rattling while promoting low frictional resistance to deployment.

Further, the opposed channel, dual C-shaped configuration of the fixed track member 182, coupled with the closed, reinforced boxed configuration of the sliding track member 370, provides relatively high strength construction. Those skilled in the art will appreciate that the fixed and sliding track members 182 and 370, thus configured, exhibit high resistance to torsional deflection or (e.g., twisting) and lateral flexure (e.g., bending).

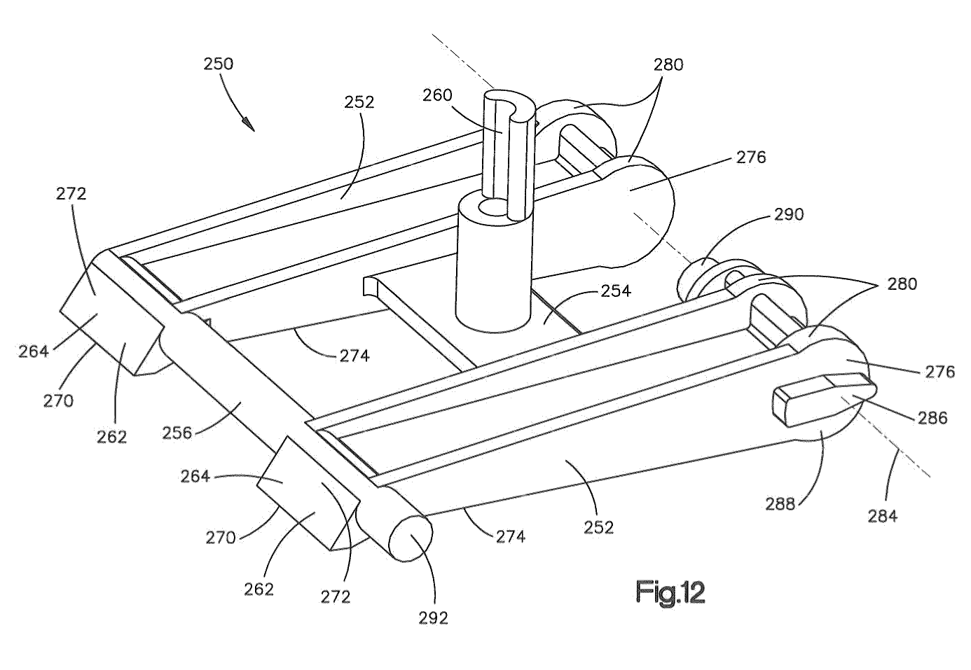

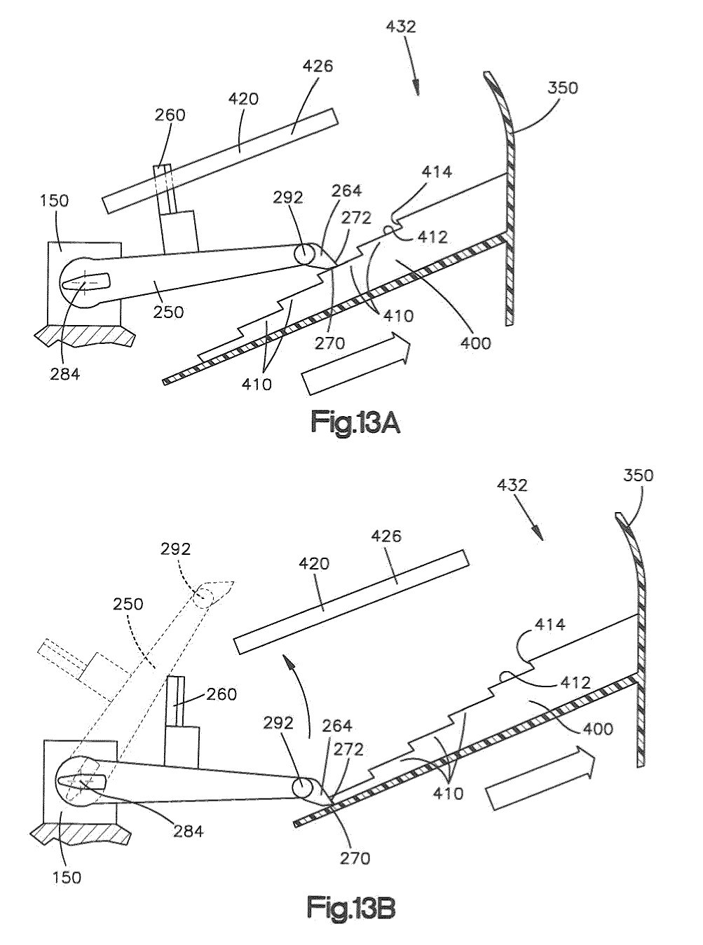

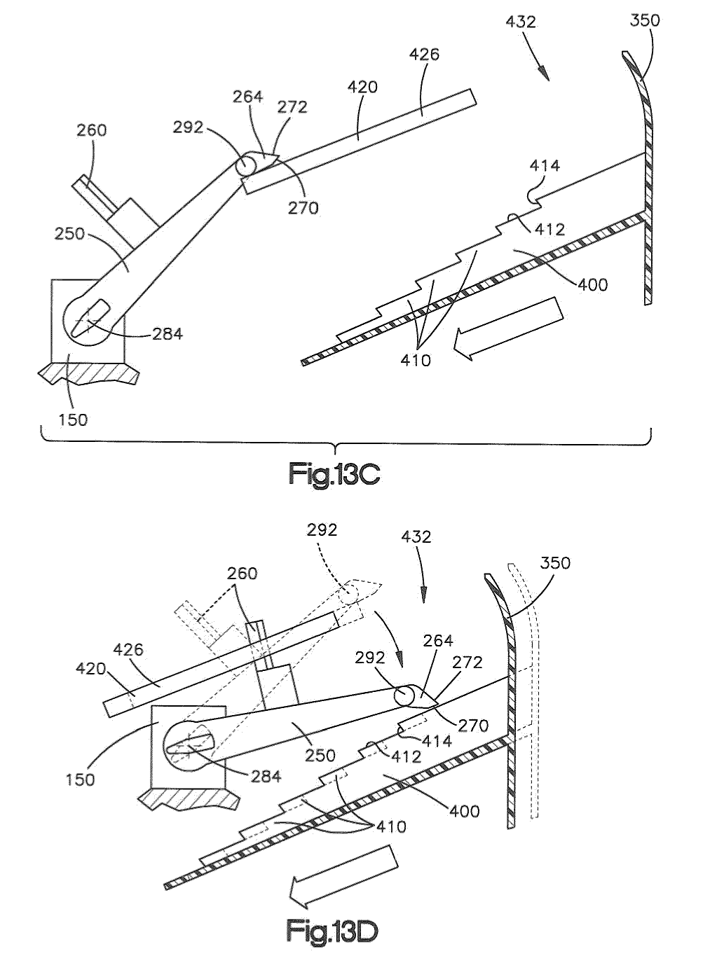

As best illustrated in FIGS. 4-5 and 13A-13D, as the cushion carrier 350 moves in the deployment direction indicated generally by the arrow in FIGS. 13A and 13B, the rack engaging portions 264 of the non-return pawl slide along the steps 410 of the corresponding latch rack portions 400. As the cushion carrier 350 moves toward the deployed condition, the lower rack engaging surfaces 270 of the rack engaging portions 264 slide over the sliding surfaces 412 of the steps 410. If the cushion carrier 350 is moved in a against the bias of the deployment spring 500 toward the non-deployed condition, the stop surfaces 272 of the rack engaging portions 264 engage the latching surfaces 414 of the steps 410 (see FIG. 13B), thus preventing further movement of the cushion carrier 350 against the bias of the deployment spring 500. The non-return mechanism thus helps to maintain the cushion carrier 350 at the forwardmost position achieved during deployment. Advantageously, if the forces urging the cushion carrier 350 opposite the deployment direction are removed, the cushion carrier 350 can resume movement in the deployment direction under the bias of the deployment spring.

The head restraint core 80 may include means for indicating that the head restraint has deployed and that resetting is required. This may be especially advantageous in an instance where the axial distance that cushion carrier 350 deploys is small and not readily noticeable. Such indicating means can be implemented in a variety of manners. As shown in FIGS. 4 and 5, in the illustrated embodiment, a deployment indicator 650 is formed on the rear cover 100 of the head restraint core 80. The deployment indicator 650 may, for example, be formed as a decal, emblem, or paint in a high visibility color and may include a message or symbol indicative of head restraint deployment. The deployment indicator 650 could be positioned in an alternative location, such as on the base frame 150.

When the actuator 640 is de-energized, the actuator pin 642 moves axially out of engagement with the actuator arm 624 of the blocking member 560. The bias of the double coil spring 564, however, maintains the latch member 552 and blocking member 560 in the actuated positions illustrated in FIG. 11C. To reset the release mechanism 510 to the non-deployed condition of FIGS. 11A and 11B, the cushion carrier 350 is moved manually along the deployment axis 18 toward the non-deployed condition against the bias of the drive spring 500. In order to move the cushion carrier 350 manually toward the non-deployed condition, however, it is necessary to move and maintain the non-return pawl 250 in a non-locking condition.

Advantageously, after deployment, the reset lever 260 on the non-return pawl 250 and the reset guide 420 on the cushion carrier 350 combine to aid in resetting the active head restraint 14 to the non-deployed condition. As shown in FIGS. 5 and 13B, when the head restraint core 80 is in the deployed condition, the reset lever 260 is accessible in the space 278 between the cushion carrier 350 and the rear cover 100. This allows the non-return pawl 250 to be urged manually to pivot about the axis 284 and move out of engagement with the latch rack portions 400 so that the cushion carrier 350 can be moved against the spring bias of the drive spring 500 toward the non-deployed condition, as indicated generally by the arrow in FIGS. 13C and 13D.

Referring to FIGS. 4, 4, 13C, and 13D, when the cushion carrier 350 is moved a predetermined distance in the deployment direction, the latch reset guide 420 moves relative to the reset pin 292 to a point at which the reset lever 260 can be released. When this occurs, the non-return pawl moves under the bias of the spring 300 so that the reset pin 292 engages the latch reset guide 420, which prevents the rack engaging portions 264 of the non-return pawl 250 from engaging the rack latch portions 402 on the cushion carrier. This allows for continued movement of the cushion carrier 350 toward the non-deployed condition without manually maintaining the non-return pawl 250 out of engagement with the latch rack portions 400.

The cushion carrier 350 can thus be moved further towards the non-deployed condition as access to the space 278 between the cushion carrier 350 and the rear cover 100 is closed-off. When the reset pin 292 clears the latch reset guide 420, the reset pin moves through the reset gap 432 on the overhang portion 426 of the latch reset guide 420, which permits the non-return pawl 250 to pivot into engagement with the latch rack portions 400 under the bias of the spring 300.

Referring to FIGS. 11A-11C, as the cushion carrier 350 is moved manually along the deployment axis 18 toward the non-deployed condition, a reset surface 644 of the hook portion 530 engages a reset surface 646 of the latch member 552, causing the latch member to pivot counterclockwise about the axis 554 as viewed in FIG. 11C against the bias of the double coil spring 564 toward the non-deployed condition. This causes the blocking member 560 to pivot counterclockwise under the bias of the double coil spring 564.

As the blocking member 560 pivots, an outer surface 618 of the spring engaging portion 616 engages and slides over an outer surface 598 of the latch arm 592. As this sliding takes place, that the corner portion 620 of the spring engaging portion 616 approaches the notch 622 in the tongue engaging portion 592. When the latch member 552 reaches the non-deployed condition, the corner portion 620 enters the notch 622, thereby placing the latching mechanism 512 in the non-deployed condition. When the force urging the cushion carrier 350 against the bias of the drive spring 500 is released, the double coil spring 564 biases the latch member 552 and the blocking member 560 against each other, thus maintaining the corner portion 620 engaged in the notch 622. This maintains the release mechanism 510 in the locking condition and thereby maintains the active headrest core 80 in the non-deployed condition of FIGS. 11A and 11B, ready for actuation via the actuator 640 as described above. The active headrest core 80 is thus configured for easy and simplified resetting.

Advantageously, the release mechanism 510, more specifically the tongue 514, latch frame 550, latch member 552, and blocking member 554, may be constructed primarily of metal components that are not as susceptible to fatigue or creep as plastic. This is beneficial since it is these components that withstand the bias of the drive spring 500 while the head restraint core 80 is maintained in the non-deployed condition. Also, in bearing the load of the drive spring 500, the tongue 514 may serve the dual purpose of transferring the driving force to the cushion carrier 350 while also providing lateral or anti-buckling support for the drive spring 500.

Referring to FIGS. 2-5 and 14A-14E, the head restraint 14 also includes an electrical connector assembly 700 for facilitating an electrical connection between an electrical system of the vehicle 12, such as the sensor 50 and lead wires 52, and a head restraint mounted component, such as the actuator 640 of the release mechanism 510. The electrical connector assembly 700 includes a first electrical connector part, hereinafter referred to as the first connector 702, that is connected to or otherwise associated with the head restraint 14 (see FIGS. 2 and 3). The electrical connector assembly 700 also includes a second electrical connector part, hereinafter referred to as the second connector 704, that is connected to or otherwise associated with the vehicle seat 20 (see FIGS. 1 and 19-21).

The first and second connectors 702 and 704 may be of any suitable connector type known in the art, such as a friction-fit male/female electrical connector. One example of such a connector is known in the art as an RCA connector. Also, the gender of the first and second connectors 702 and 704 may be interchangeable. Thus, in the illustrated embodiments, the first connector 702 may be a female connector and the second connector 704 a male connector, or vice versa.

The connector assembly 700 also includes an auto-connect tube 710 that is associated with the vehicle seat 20. The auto-connect tube 710 is generally cylindrical in form and has a body portion 712 defining an interior chamber 714 that extends along a central longitudinal axis 738 of the auto-connect tube 710. A connector portion 716 located at a first or upper end 718 of the auto-connect tube 710 includes a series of retention clips 720 arranged peripherally about the end of the tube.

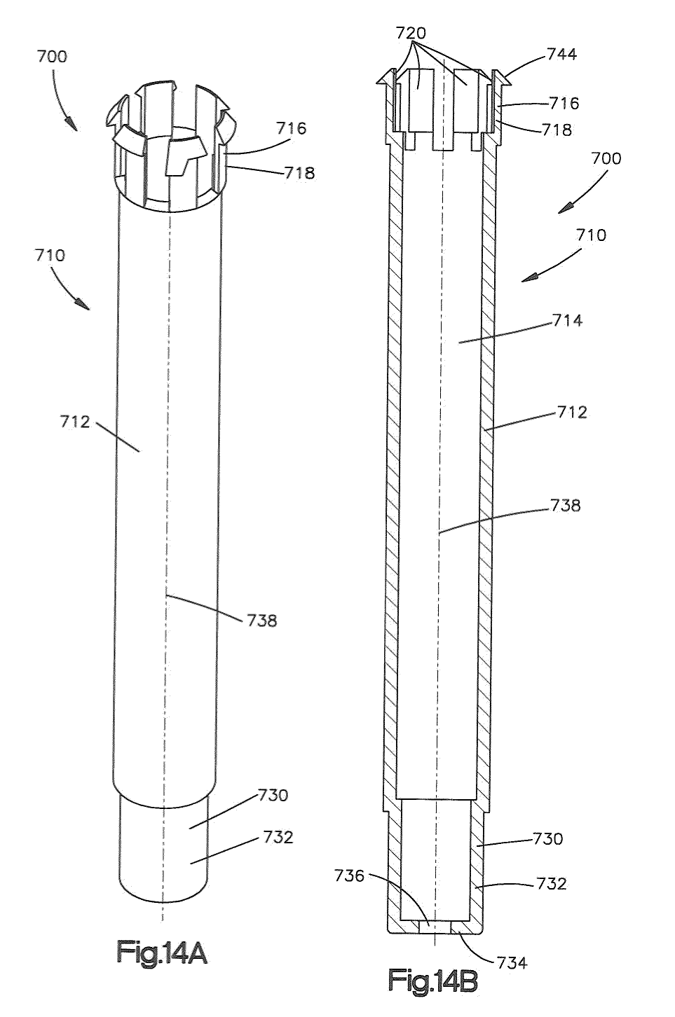

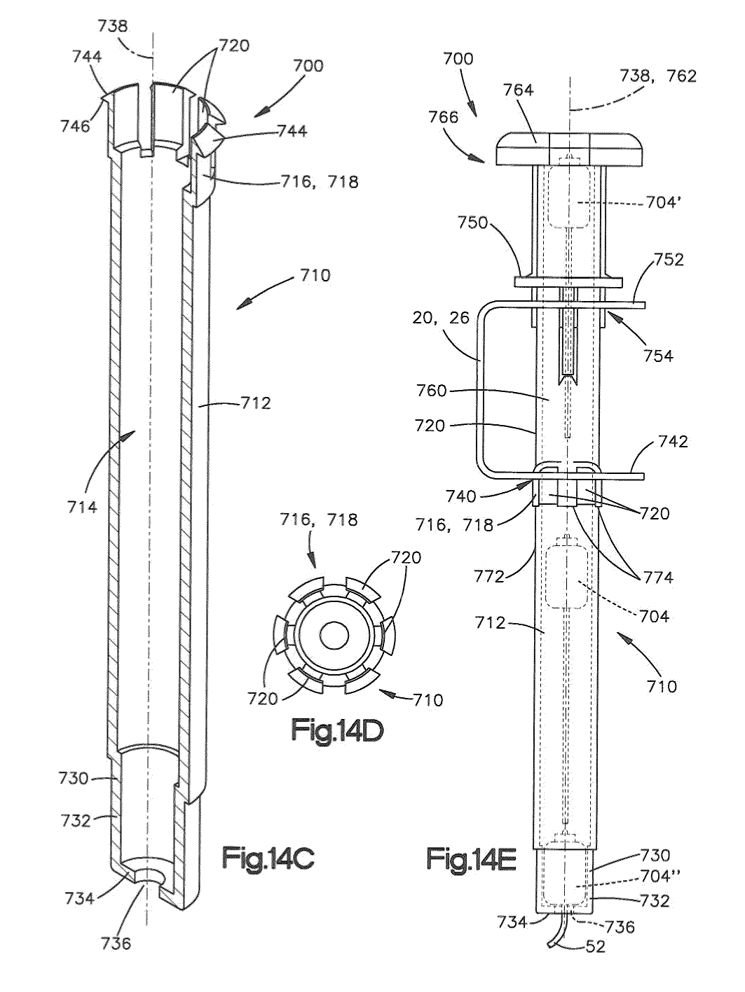

At a second or lower end 730 of the auto connect tube 710 opposite the upper end 718, the tube includes a connector receiving portion 732. As shown in FIG. 14, the connector receiving portion 732 may have a diameter slightly reduced from that of the body portion 712. The connector receiving portion 732 terminates with an end wall 734, through which a wire receiving aperture 736 extends.

To secure the auto-connect tube 710 to the seat frame 26, the connector portion 716 is passed through an opening 740 in a lower member 742 of the frame. The retention clips 720 have angled surfaces 744 that engage the seat frame 26 about the periphery of the opening 740 as they initially pass through the opening, causing the clips to deflect inward toward the axis 738. Once through the opening 740, the clips 720 snap into place, with lower surfaces 746 of the clips engaging the frame 26 and preventing the auto-connect tube 710 from being removed from the frame.

Once the auto-connect tube 710 is connected to the seat frame 26, a head restraint guide/height adjustment sleeve 750 is inserted through the top of the seat 20 and through a corresponding opening 752 in an upper member 754 of the seat frame 26. The adjustment sleeve 750 is generally cylindrical in form and has a body portion 760 that extends along a central longitudinal axis 762 of the adjustment sleeve 750. The adjustment sleeve 750 is constructed to accommodate the support members 40 of the head restraint 14 to connect the head restraint to the vehicle seat 20.

A head restraint position locking mechanism 764 is located at a first or upper end 766 of the adjustment sleeve 750. At a second or lower end 770 of the adjustment sleeve 750 opposite the upper end 766, the sleeve includes a connector portion 772. The connector portion 772 engages and interfaces with the connector portion 716 of the auto-connect tube 710 and prevents the clips 720 from deflecting toward the axis 738, thus preventing the auto-connect tube from being removed from the seat frame 26. When the adjustment sleeve 750 is inserted through the top of the vehicle seat 20 and engages the auto-connect tube 710, the position locking mechanism 764 abuts the top of the seat.

FIG. 14E illustrates an auto-connect tube connected to a vehicle seat frame 26. The connector portion 772 may, for example, include a series of securing clips 774 arranged peripherally about the end of the adjustment sleeve 750. When the adjustment sleeve 750 interfaces with the auto-connect tube 710, the securing clips 774 on the adjustment sleeve engage the retention clips 720 on the auto-connect tube.

With the auto-connect tube 710 secured to the seat frame 26, a vehicle power cable 780, e.g., lead wire 52, is positioned in the chamber 714 with the second connector 704 positioned proximate the upper end portion 718. In the embodiment illustrated in FIG. 14E, the second connector 704 is a male RCA connector. Once the adjustment sleeve 750 is installed in the manner described above, the second connector 704 may be positioned proximate head restraint position locking mechanism 764. This is illustrated generally in dashed lines at 704′ in FIG. 14E. Alternatively, the second connector 704 may be capable of extending through the head restraint position locking mechanism 764.

The second connector 704 is free to move within the adjustment sleeve 750 and the auto-connect tube 710. The interior diameter of the sleeve 750 and the tube 710 may be selected to maintain the second connector 704 oriented with the connector pin substantially aligned with the axis 738. The diameter of the opening 736 in the end wall 734 of the auto-connect tube 710 creates an interference that prevents the second connector 704 from leaving the chamber 714. This is illustrated generally in dashed lines at 704″ in FIG. 14E.

When the support members 40 are inserted in the adjustment sleeves 750 to connect the head restraint 14 to the vehicle seat 20, the first connector 702 urges the second connector 704 toward and into the connector receiving portion 732 at the lower end 730 of the auto connect tube 710. Due to the interference between the second connector 704 and the opening 736 in the end wall 734, the second connector 704 bottoms out in the connector receiving portion 732, which forces the first connector 702 into mating engagement with the second connector. The mating engagement between the first connector 702 and the second connector 704 electrically connects the head restraint 14 to the vehicle seat 20. The first connector 702 may protrude from the support member 40 (shown), be flush with the support member, or be recessed in the support member.

When the head restraint 14 is removed, the connection between the first connector 702 and the second connector 704 can be broken manually by pulling the connectors apart outside the adjustment sleeve 750. Alternatively, the connection can be broken automatically by providing an interference that blocks the second connector 704 from leaving the adjustment sleeve 750 such that, when the head restraint 14 is removed from the vehicle seat 20, the interference causes the first connector 702 to disengage from the second connector 704. Similarly, connecting the first and second connectors 702 and 704 can be performed manually outside the adjustment sleeve 750, if desired.

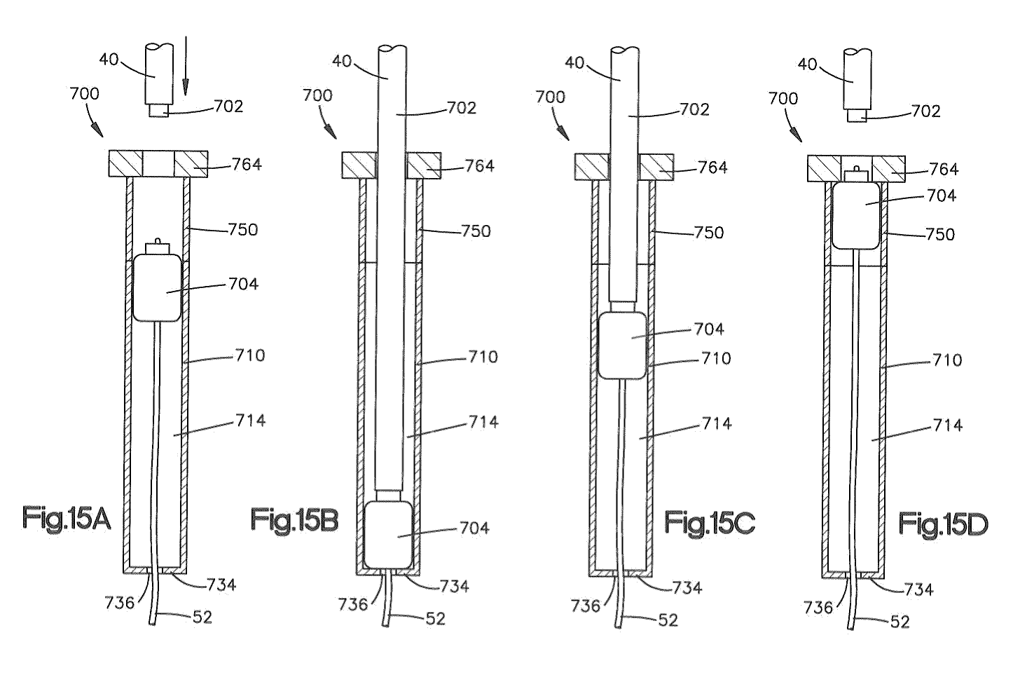

The automatic connection and disconnection of the first and second connectors described above is detailed schematically in FIGS. 15A-15D. Referring to FIG. 15A, the second connector 704 is disposed in the chamber 714 defined by the assemblage of the auto connect tube 710 and the adjustment sleeve 750. The lead wire 52 extends from the second connector 704 through the wire receiving aperture 736 in the end wall 734. The second connector 704 may be positioned at any location along the length of the chamber 714. The position of the second connector 704 illustrated in FIG. 15A is by way of example only.

When the head restraint is installed on the vehicle seat, the support member 40 moves through the locking mechanism 764 and into the chamber 714, as shown by the transition from FIG. 15A to FIG. 15B. Referring to FIG. 15B, when the support member 40 moves downward into the chamber 14, it urges the second connector 704 to move axially toward the end wall 734. Eventually, further axial movement of the second connector 704 is impeded or blocked due to the interference between the second connector and the end wall 734. At this point, further downward movement of the support member 40 overcomes the frictional resistance between the first and second connectors 702 and 704, causing them to become interconnected. Once interconnected, the second connector 704 is secured to the support member 40 and moves axially in the chamber 714 as the position of the head restraint is adjusted. This is illustrated in FIG. 15C.

When the head restraint is removed from the vehicle seat, the support member 40 axially upward in the chamber 714 and exits through the locking mechanism 764. Referring to FIG. 15D, when the support member 40 moves upward in the chamber 14, it brings along the second connector 704, which moves into the adjustment sleeve 750 toward the locking mechanism 764. Eventually, further axial movement of the second connector 704 is impeded or blocked from leaving the adjustment sleeve 750 due to an interference, which can be formed, for example, by the locking mechanism 764 or another portion of the adjustment sleeve. At this point, further upward movement of the support member 40 overcomes the frictional resistance between the first and second connectors 702 and 704, causing them to become disconnected. The connector assembly 700 thereby provides for automatic connection and disconnection of the first and second connectors 702 and 704.

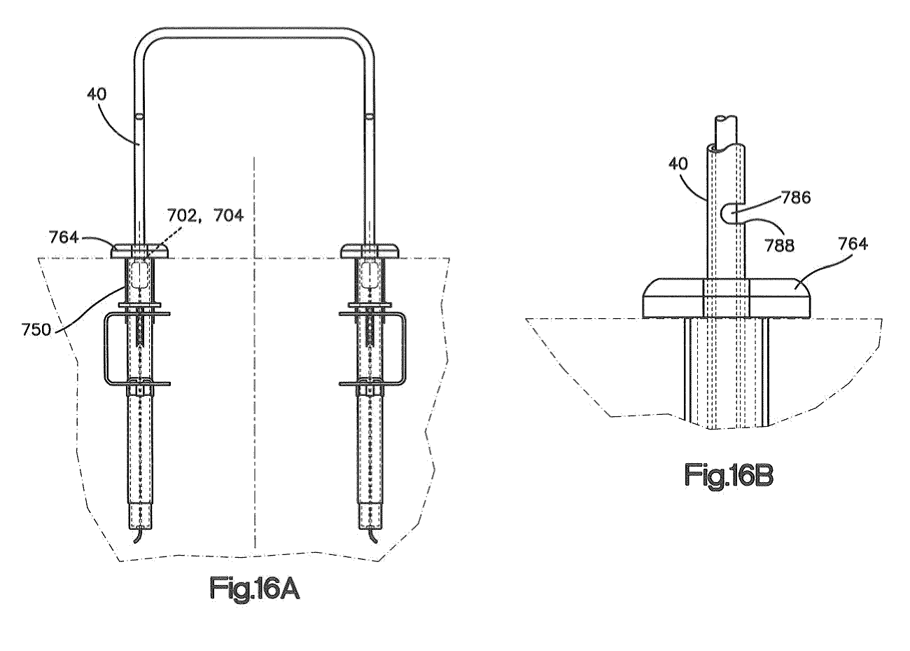

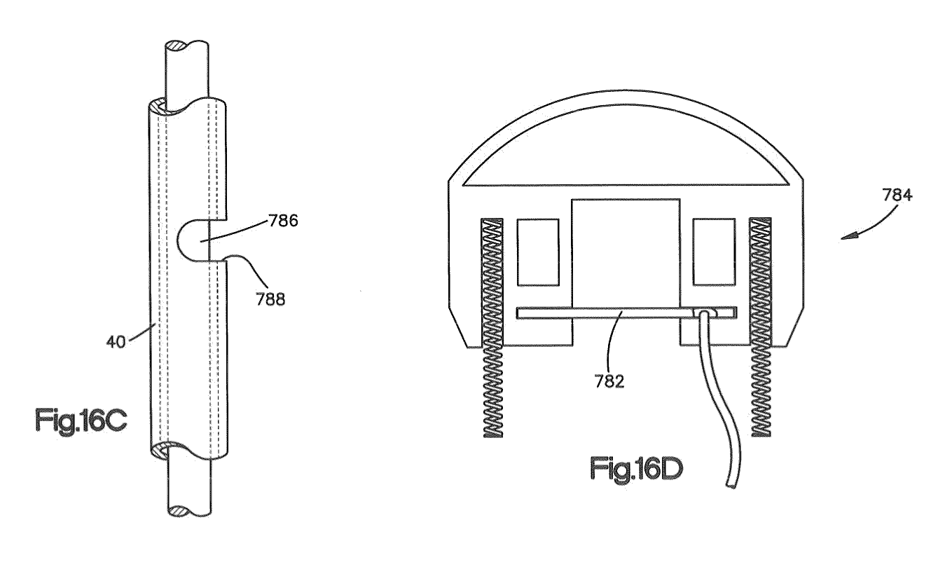

An alternative embodiment for providing electrical power to the head restraint 14 is shown in FIGS. 16A-16D. In this embodiment, power is supplied at the seat to the adjustment sleeve 750 and is received through a power wire or bus rod 786 located inside the support members 40. For example, one support member 40 may be associated electrically with positive vehicle voltage and the other support member may be associated electrically with negative or ground. To achieve this connection, electrical power may be fed to the seat 20 and terminated in the locking mechanism(s) 764 of the adjustment sleeve 750. Referring to FIG. 16D, the power connection may be terminated in a locking bar 782 on a spring biased slider 784 of the locking mechanism 764. The bus rod 786 in the support member 40 may be exposed via locking apertures 788 spaced along the length of the support member 40.

When the head restraint 14 is adjusted to a desired position, the slider 784 is released to lock the head restraint in the desired position. This causes the locking bar 782 to become biased against the bus rod 786 under the spring bias of the slider, thus establishing the desired electrical connection between the locking bar and the bus rod and, therefore, the head restraint 14 and the vehicle seat 20. Since it may not be desirable to provide a locking mechanism on both support members 40 of the same head restraint 14, the other support member may be associated with ground and thus be maintained in constant electrical connectivity with vehicle ground. This may be accomplished via a similar spring biased engagement on a support member that is free of locking apertures. For example, since this connection is with vehicle ground, the support member itself could serve this function.

From the above, those skilled in the art will appreciate that the electrical connector assembly 700 helps aid in the assembling and disassembling of the head restraint 14 on the vehicle seat 26. The electrical connector assembly 700 allows the head restraint 14 to be adjusted in the seat frame 26, while maintaining its electrical connection between the actuator and the power source.

It may be desirable, for example, to remove the head restraint from the seat 20 when folding the seat to allow for more cargo room. The electrical connector assembly 700 allows a user to effectively and efficiently uninstall and then reinstall the head restraint 14 in the vehicle seat 20 whenever necessary.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for providing an electrical connection between a vehicle seat mounted head restraint and an electrical system of the vehicle, the apparatus comprising:
a first electrical connector secured to a support member of the head restraint, the first electrical connector being adapted to deliver an electrical signal to a component mounted to the head restraint;
a second electrical connector associated with the electrical system of the vehicle; and
an auto-connect component connectable to the vehicle seat and being adapted to receive the support member of the head restraint and the first electrical connector upon installation of the head restraint on the vehicle seat, the auto-connect component being further adapted to support the second electrical connector and being configured such that the first and second electrical connectors are interconnected automatically upon installing the head restraint on the vehicle seat, the auto-connect component being further configured such that the first and second electrical connectors are disconnected automatically upon un-installing the head restraint from the vehicle seat.

2. The apparatus recited in claim 1, wherein the auto-connect component comprises an interior chamber configured to receive the second electrical connector, the auto-connect component being configured to maintain the second electrical connector at a desired orientation in the chamber and permit sliding movement of the second electrical connector in opposite directions along a longitudinal axis in the chamber.

3. The apparatus recited in claim 2, wherein the auto-connect component is configured to impede movement of the second electrical connector in a first direction to cause the first and second electrical connectors to interconnect during installation of the head restraint on the vehicle seat, the auto-connect component being further configured to impede movement of the second electrical connector in a second direction opposite the first direction to cause the first and second electrical connectors to disconnect during removal of the head restraint from the vehicle seat.

4. The apparatus recited in claim 2, wherein the auto-connect component comprises an auto-connect tube having an upper end portion and an opposite lower end portion, the second electrical connector being moveable in the auto-connect tube along the longitudinal axis in a first direction away from the upper end portion toward the second end portion in response to the support member being inserted in the auto-connect tube during installation of the head restraint, the lower end portion comprising a connector receiving portion adapted to receive the second electrical connector and block further movement of the second electrical connector in the first direction in order to force the first and second electrical connectors into interconnecting engagement with each other upon further insertion of the support member.

5. The apparatus recited in claim 4, wherein the second electrical connector being interconnected with the first electrical connector is urged to move in a second direction opposite the first direction in response to the support member being removed from the auto-connect tube when the head restraint is removed from the vehicle seat, the auto-connect tube being configured to form an interference that blocks the second electrical connector from moving in the second direction beyond a predetermined point in order to force the first and second electrical connectors to disconnect upon removal of the head restraint from the vehicle seat.

6. The apparatus recited in claim 1, wherein the auto connect component comprises an auto connect tube, the auto connect tube comprising:
a body portion having a generally cylindrical side wall that helps define the interior chamber;
a connector portion located at an upper end of the body portion, the connector portion comprising a plurality of retention clips arranged peripherally about the end of the side wall, the retention clips cooperating with a seat frame of the vehicle seat to help connect the auto-connect tube to the vehicle seat; and
a connector receiving portion located at a lower end of the body portion opposite the upper end, the connector receiving portion comprising a cylindrical side wall that is aligned axially with the body portion, and a terminal end wall, the end wall comprising a wire receiving aperture for receiving a conductor connected to the second electrical connector.

7. The apparatus recited in claim 1, wherein the auto connect component comprises an auto connect tube and an adjustment sleeve connectable with the auto-connect tube to help secure the auto-connect tube to the vehicle seat, the adjustment sleeve receiving the support member and directing the support member into an interior chamber of the auto connect tube, the adjustment sleeve comprising a locking mechanism that engages locking apertures in the support member to maintain the head restraint at a desired position relative to the vehicle seat.

8. The apparatus recited in claim 1, wherein the first electrical connector is disposed on a terminal end portion of the head restraint support member.

9. The apparatus recited in claim 1, wherein the first and second electrical connectors comprise friction fit connectors that provide a friction-fit connection with each other to facilitate the automatic connection during installation of the head restraint on the vehicle seat that the automatic disconnection upon un-installing the head restraint from the vehicle seat.

10. The apparatus recited in claim 1, wherein:
the first electrical connector comprises an electrical conductor supported internally within the support member, the support member comprising locking apertures that expose portions of the conductor along the length of the support member; and
the second electrical connector comprises a locking member of a locking mechanism that receives the support member, the locking member having a locking position biased into an adjacent one of the locking apertures to lock the head restraint in a desired position, the locking member when in the locking position engaging the conductor and establishing an electrical connection between the conductor and the electrical system of the vehicle.

11. The apparatus recited in claim 1, wherein the head restraint mounted component comprises an active head restraint actuatable to place the head restraint in an actuated condition for helping to protect the vehicle occupant.

12. An apparatus for providing an electrical connection between a vehicle seat mounted head restraint and an electrical system of the vehicle, the apparatus comprising:
a first electrical connector associated with the head restraint and being for delivering an electrical signal to a component mounted to the head restraint;
a second electrical connector associated with the electrical system of the vehicle;
an auto-connect tube connectable to the vehicle seat, the auto-connect tube comprising a sidewall that helps define an interior chamber of the auto-connect tube, the second electrical connector being disposed in the interior chamber of the auto-connect tube, the auto-connect tube and the second electrical connector being configured such that the second electrical connector is blocked from being removed from the interior chamber and such that the second electrical connector is maintained at a desired orientation in the interior chamber so that the first and second electrical connectors are interconnected automatically when the head restraint is installed on the vehicle seat.

13. An apparatus comprising:
a vehicle seat having a seat frame;
a head restraint connectable to the vehicle seat, the head restraint comprising a support member; and
an electrical connector assembly for providing an electrical connection with a head restraint mounted component, the electrical connector assembly comprising:
a first electrical connector connected to the support member, the first electrical connector being for supplying an electrical signal to the head restraint mounted component;
a second electrical connector connected to the vehicle seat, the second electrical connector being connected to a source of a vehicle electrical signal;
an auto-connect tube secured to the vehicle seat frame and supporting the second electrical connector, the auto-connect tube being adapted to receive the support member and to position and support the second electrical connector to automatically interconnect with the first electrical connector when the head restraint is installed on the vehicle seat.
